(19) United States
(12) Patent Application Publication
(10) Pub. No.: US 2022/0319529 A1
(43) Pub. Date: Oct. 6, 2022

(54) COMPUTER-READABLE RECORDING MEDIUM STORING NOISE DETERMINATION PROGRAM, NOISE DETERMINATION METHOD, AND NOISE DETERMINATION APPARATUS

(71) Applicant: FUJITSU LIMITED, Kawasaki-shi (JP)

(72) Inventor: Naoshi MATSUO, Yokohama (JP)

(73) Assignee: FUJITSU LIMITED, Kawasaki-shi (JP)

(21) Appl. No.: 17/577,159

(22) Filed: Jan. 17, 2022

(30) Foreign Application Priority Data
Mar. 31, 2021 (JP) 2021-060888

(51) Int. Cl. G10L 21/0232; G10L 21/0264; G10L 25/84

(52) U.S. Cl. CPC G10L 21/0232; G10L 21/0264; G10L 25/84; G10L 2021/02087

(57) ABSTRACT

A non-transitory computer-readable recording medium stores a noise determination program for causing a computer to execute a process including: comparing a sound pressure level for each frequency with a sound pressure level in a band having a frequency lower than a threshold value, in a spectrum of a voice signal; and determining whether a component corresponding to each frequency is a voice or noise, based on a similarity between the sound pressure level for each frequency and the sound pressure level in the band.

### CROSS-REFERENCE TO RELATED APPLICATION

This application is based upon and claims the benefit of priority of the prior Japanese Patent Application No. 2021-60888, filed on Mar. 31, 2021, the entire contents of which are incorporated herein by reference.

### FIELD

The embodiments discussed herein are related to a noise determination technique.

### BACKGROUND

With the spread of telework, calls and meetings using softphones and the like are increasing. For example, in a case where an omnidirectional monaural microphone coupled to the middle of an earphone cable is used, a keystroke sound of a keyboard or a voice from the surroundings may be mixed in a transmission conversation voice as high-level non-stationary noise. Thus, from the viewpoint of improving the transmission conversation quality, it is desired to suppress the non-stationary noise mixed in the transmission voice in the monaural signal.

Japanese Laid-open Patent Publication No. 2006-243644 is disclosed as related art.

### SUMMARY

According to an aspect of the embodiments, a non-transitory computer-readable recording medium stores a noise determination program for causing a computer to execute a process including: comparing a sound pressure level for each frequency with a sound pressure level in a band having a frequency lower than a threshold value, in a spectrum of a voice signal; and determining whether a component corresponding to each frequency is a voice or noise, based on a similarity between the sound pressure level for each frequency and the sound pressure level in the band.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a functional configuration of a signal processing apparatus;

FIG. 2 is a diagram illustrating an example of a power spectrum of a voice;

FIG. 3 is a schematic diagram illustrating an example of a range of a masking effect;

FIG. 4 is a schematic diagram illustrating an example of a power spectrum;

FIG. 5 is a schematic diagram illustrating another example of the power spectrum;

FIG. 6 is a block diagram illustrating an example of a functional configuration of a noise determination unit;

FIG. 7 is a diagram illustrating an example of a relationship between a signal-to-noise ratio (SNR) and an upper limit value of a suppression gain;

FIG. 8 is a diagram illustrating an example of a relationship between the suppression gain, the upper limit value of the suppression gain, and a similarity;

FIG. 9 is a flowchart illustrating a procedure of signal processing;

FIG. 10 is a diagram illustrating an example of an input signal of a noise-mixed voice;

FIG. 11 is a diagram illustrating an example of a power spectrum of non-stationary noise;

FIG. 12 is a diagram illustrating an example of a power spectrum of the voice and the non-stationary noise;

FIG. 13 is a diagram illustrating an example of a noise-mixed voice signal after suppression of the non-stationary noise;

FIG. 14 is a diagram illustrating an example of a power spectrum after suppression of the non-stationary noise;

FIG. 15 is a block diagram illustrating an example of a functional configuration of a signal processing apparatus according to an application example;

FIG. 16 is a block diagram illustrating an example of a functional configuration of a noise determination unit;

FIG. 17 is a diagram illustrating an example of a relationship between the suppression gain and the similarity;

FIG. 18 is a flowchart illustrating a procedure of signal processing according to the application example; and

FIG. 19 is a diagram illustrating an example of a hardware configuration.

### DESCRIPTION OF EMBODIMENTS

For stationary noise in which a change in power on a time axis is small, such as a fan noise of a computer or air conditioning, a noise suppression technique of a spectral subtraction type in which a power spectrum of the stationary noise is estimated and subtracted from a power spectrum of a noise-mixed voice is widely used.

However, in the related art described above, just stationary noise having a small power change is handled. Thus, there is one aspect that it is difficult to suppress non-stationary noise having a large power change, such as a keystroke sound of a keyboard. A microphone array in which non-stationary noise may also be set as a suppression target by using a difference in a sound source position has a limitation in terms of a wide space and cost. Thus, there is one aspect that an application range is limited.

According to one aspect, an object of the present disclosure is to provide a noise determination program, a noise determination method, and a noise determination apparatus that may suppress non-stationary noise included in a voice signal.

Hereinafter, an embodiment of a noise determination program, a noise determination method, and a noise determination apparatus according to the present application will be described with reference to the accompanying drawings. Individual embodiments are merely examples or aspects, and ranges of numerical values and functions, a usage scene, and the like are not limited by such examples. Individual embodiments may be appropriately combined within a range not causing any contradiction in processing content.

### First Embodiment

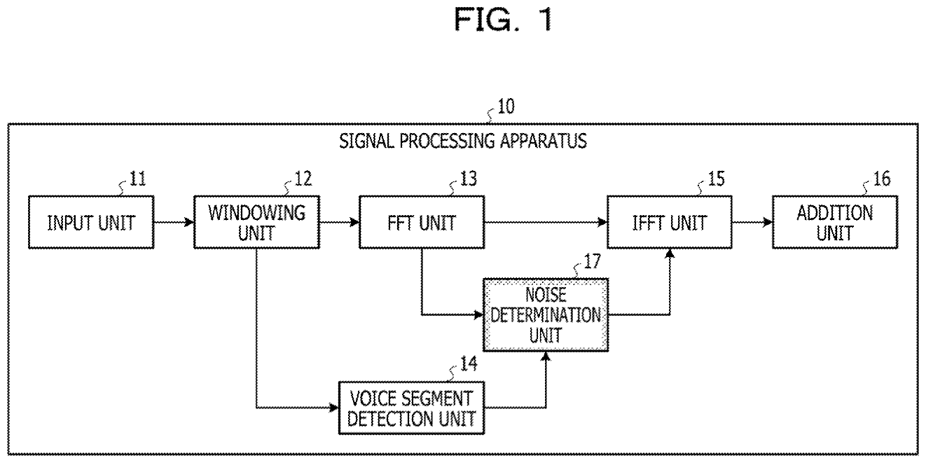

FIG. 1 is a block diagram illustrating an example of a functional configuration of a signal processing apparatus. A signal processing apparatus 10 illustrated in FIG. 1 provides a signal processing function of processing a noise-mixed voice signal. As a portion of such a signal processing function, a noise determination function for determining and suppressing noise mixed in a voice signal is provided.

As one aspect, the noise determination function may target a monaural signal among noise-mixed voice signals, and may target determination and suppression of non-stationary noise such as a keystroke sound of a keyboard or a surrounding conversation voice among types of noise.

### Example of Usage Scene

As one aspect, the above-described noise determination function may be added as a function installed on an exchanger for a call center. As another aspect, the above-described noise determination function may be added to an application of a softphone or a web conference. As a further aspect, the above-described noise determination function may be realized as firmware of a microphone unit.

The above-described noise determination function may also be realized as a function of a library referenced by the front end of a cloud type service, for example, a voice recognition service or a voice analysis artificial intelligence (AI), and the like for example, an application programming interface (API).

### One Aspect of Characteristics of Voice

Vowels, for example, “a”, “i”, “u”, “e”, “o”, and the like are uttered by generating a pulse signal sequence on a time axis due to vibration of vocal cords and generating resonance in a vocal tract from the vocal cords to a mouth.

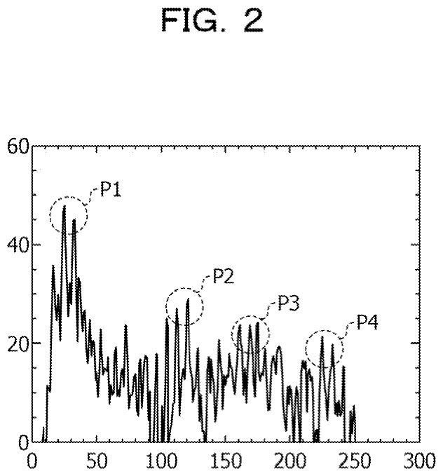

FIG. 2 is a diagram illustrating an example of a power spectrum of a voice. A horizontal axis of a graph illustrated in FIG. 2 indicates a frequency, and a vertical axis of the graph indicates power of a voice at each frequency, for example, a sound pressure level. Frequencies on the horizontal axis are an example of a case where 4 kHz is quantized with 256 points. According to the power spectrum illustrated in FIG. 2, it is apparent that the pulse signal sequence characteristic due to the vibration of vocal cords has a so-called harmonic structure in which fine peaks and valleys are repeated. It may be seen that the articulation characteristic of the vocal tract has a low-pass characteristic having high transmission in a low frequency band and a band-pass characteristic having a plurality of peaks, for example, four peaks corresponding to bands P1 to P4 illustrated in FIG. 2.

### Masking Effect

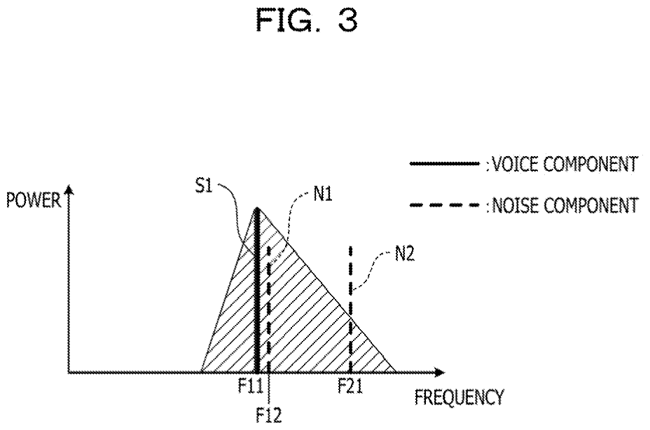

FIG. 3 is a schematic diagram illustrating an example of a range of a masking effect. A horizontal axis of a graph illustrated in FIG. 3 indicates a frequency, and a vertical axis of the graph indicates power. As an example, in FIG. 3, a voice component S1 is indicated by a solid and thick line, and noise components N1 and N2 are indicated by broken and thick lines. In FIG. 3, the range of the masking effect by the voice component S1 is illustrated in a hatched manner.

As illustrated in FIG. 3, it is assumed that a frequency F11 is the frequency of the voice component S1. In this case, the power of the noise component N1 having a frequency F12 in the vicinity of the frequency F11 is within the range of the masking effect of the voice component S1. Therefore, the noise component N1 is masked by the voice component S1, and thus is not perceived. On the other hand, the masking effect of the voice component S1 is small for the noise component N2 having a frequency F21 that is not in the vicinity of the frequency F11. The power of the noise component N2 exceeds the threshold value of the sense of hearing, and thus is perceived.

### One Aspect of Problem

In related art for suppressing non-stationary noise, which is different from the noise suppression technique of the spectral subtraction type described in BACKGROUND, a high-level noise component is suppressed up to a level of an envelope of a power spectrum of a voice on a frequency axis.

However, in the related art described above, a residual component of noise, to which the masking effect of a voice component is not applied, is perceived. Thus, there is one aspect that it is difficult to suppress non-stationary noise having a large power change as compared with stationary noise.

Examples of such a case where the masking effect of the voice component is not applied include a case where the power of the voice component is low in the vicinity of the frequency of the residual component of noise and a case where the voice component is absent in the vicinity of the frequency of the residual component of noise. For example, in a vowel among voices, for example, a power spectrum has a harmonic structure of peak and valley repetition due to periodic vibration of the vocal cords being a vocal organ. Thus, a band in which a voice component has low power is likely to occur.

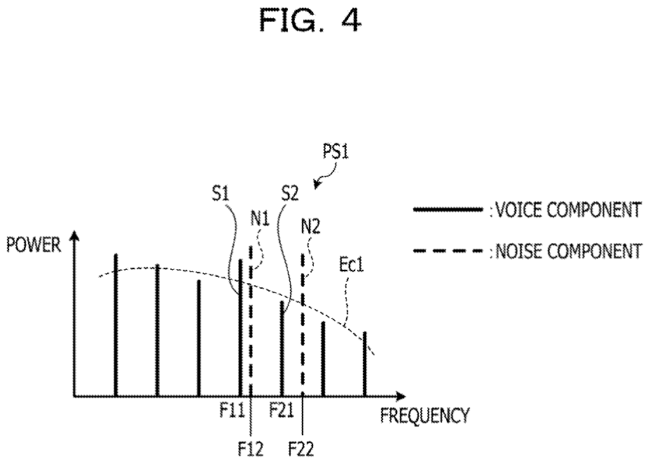

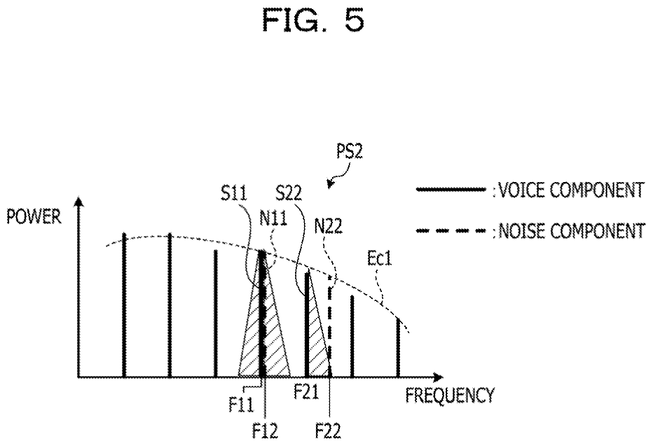

FIGS. 4 and 5 are schematic diagrams illustrating examples of the power spectrum. FIG. 4 illustrates a power spectrum PS1 of an original sound (voice+noise), and FIG. 5 illustrates a power spectrum PS2 after suppression according to the above-described related art for suppressing the non-stationary noise. A horizontal axis of a graph illustrated in FIGS. 4 and 5 indicates a frequency, and a vertical axis of the graph indicates power. In FIG. 4, voice components S1 and S2 are indicated by solid and thick lines, and noise components N1 and N2 are indicated by broken and thick lines. In FIG. 5, voice components S11 and S22 after suppression are indicated by solid and thick lines, and noise components N11 and N22 after the suppression are indicated by broken and thick lines. In FIG. 5, the range of the masking effect by the voice components S11 and S22 is illustrated in a hatched manner.

For example, in the above-described related art, an envelope Ec1 is obtained by calculating a low-frequency band envelope from the power spectrum PS1 of the original sound illustrated in FIG. 4, and then calculating an estimation envelope from the low-frequency band envelope. The power spectrum PS2 after the suppression, which is illustrated in FIG. 5, is obtained by suppressing the power spectrum PS1 of the original sound to the envelope Ec1. As a result, the noise component N1 is suppressed to the noise component N11, and the noise component N2 is suppressed to the noise component N22. Among the noise components, the frequency F12 of the noise component N11 is in the vicinity of the frequency F11 of the voice component S11, and the noise component N11 is within the range of the masking effect of the voice component S11. Therefore, the noise component N11 is masked by the voice component S11, and thus is not perceived. On the other hand, the masking effect of the voice component S22 is small for the noise component N22 having a frequency F22 that is not in the vicinity of the frequency F21. The power of the noise component N22 exceeds the threshold value of the sense of hearing, and thus is perceived.

As described above, in the above-described related art, in a case where the power of the voice component S22 is low in the vicinity of the frequency F22 of the noise component N22, the masking effect of the voice component S22 is not applied. Thus, the noise component N22 is perceived.

### One Aspect of Problem-Solving Approach

The noise determination function according to the present embodiment solves the problem by an approach of determining and suppressing, as non-stationary noise, a signal component of a frequency having a low similarity among similarities between a temporal change in power in a low frequency band and temporal changes in power at the respective frequencies, in a monaural signal.

A motivation for such a problem-solving approach is obtained with the following technical knowledge first. For example, since a voice is generated by resonance in a vocal tract having a band-pass characteristic in which the vibration and the like of vocal cords being a vocal organ is emphasized in a low frequency band, temporal changes in power are similar in a wide band from a low frequency to a high frequency on a frequency axis. Thus, by using a temporal change in power in a low frequency band in which the level of a voice component is high as a power change of the voice component and detecting a similarity to the temporal change in power at each frequency, it is possible to determine a frequency component having a low similarity as non-stationary noise different from a voice and suppress the non-stationary noise. For example, it is possible to realize suppression that targets non-stationary noise mixed in a monaural signal by gain multiplication of less than 1. As a result, it is possible to suppress the power of the residual component of noise corresponding to the non-stationary noise up to a level that does not exceed the threshold value for perception by the sense of hearing or a level at which the masking effect by the voice component is obtained.

Thus, with the noise determination function according to the present embodiment, it is possible to suppress the non-stationary noise included in the voice signal.

### Configuration of Signal Processing Apparatus

Next, an example of a functional configuration of the signal processing apparatus according to the present embodiment will be described next. FIG. 1 schematically illustrates blocks corresponding to the signal processing function described above. As illustrated in FIG. 1, the signal processing apparatus 10 includes an input unit 11, a windowing unit 12, a fast Fourier transform (FFT) unit 13, a voice segment detection unit 14, an inverse FFT (IFFT) unit 15, an addition unit 16, and a noise determination unit 17.

The input unit 11 is a processing unit configured to input an input signal that is a noise-mixed voice to the windowing unit 12. As merely an example, the input signal may be acquired from a microphone (not illustrated), for example, a monaural microphone. As another example, the input signal may be acquired via a network. The input signal may also be acquired from a storage, a removable medium, or the like. As described above, the input signal may be acquired from an arbitrary source.

The windowing unit 12 is a processing unit configured to multiply data of the input signal that is the noise-mixed voice by a window function having a specific analysis frame length on a time axis. As an example, the windowing unit 12 applies a window function, for example, a Hanning window by extracting a frame having a specific time length from the input signal input by the input unit 11, for each frame period. At this time, from the viewpoint of reducing an information loss due to the window function, the windowing unit 12 may overlap the preceding and following analysis frames at an arbitrary ratio. For example, the overlap rate may be set to 50% by setting a fixed length, for example, 512 samples, as the analysis frame length at regular intervals, for example, every 256 samples in the frame period. The analysis frame obtained in this manner is output to the FFT unit 13 and the voice segment detection unit 14.

The FFT unit 13 is a processing unit configured to perform an FFT, so-called a fast Fourier transform. As an example, the FFT unit 13 applies an FFT to the analysis frame to which the window function is applied by the windowing unit 12. Thus, the input signal in the analysis frame is transformed into an amplitude spectrum and a phase spectrum. Then, the FFT unit 13 calculates a power spectrum from the amplitude spectrum obtained by the FFT and outputs the power spectrum to the noise determination unit 17, and outputs the phase spectrum obtained by the FFT to the IFFT unit 15. Although an example in which the FFT is applied has been described above, another algorithm such as a Fourier transform or a discrete Fourier transform may be applied to transform from a time domain to a frequency domain.

The voice segment detection unit 14 is a processing unit configured to detect a voice segment. As an example, the voice segment detection unit 14 may detect the start and end of a voice segment based on the amplitude and 0 crossing of the input signal. As another example, the voice segment detection unit 14 may calculate a voice likelihood and a non-voice likelihood in accordance with the Gaussian mixture model (GMM) for each analysis frame, and detect a voice segment from a ratio between the voice likelihood and the non-voice likelihood. Thus, for each analysis frame of the input signal, the analysis frame is labeled as a voice segment or a non-voice segment. Then, the voice segment detection unit 14 outputs the label of the analysis frame, for example, the voice segment or the non-voice segment, the likelihood thereof, or the like to the noise determination unit 17.

The IFFT unit 15 is a processing unit configured to perform an IFFT, so-called an inverse fast Fourier transform. As an example, the IFFT unit 15 applies an IFFT to an amplitude spectrum obtained from the phase spectrum output by the FFT unit 13 and the power spectrum output after the suppression gain multiplication by the noise determination unit 17. Thus, the spectrum is inversely transformed into a temporal waveform having the analysis frame length. The temporal waveform having the analysis frame length, which is obtained by the IFFT in this manner, is output to the addition unit 16.

The addition unit 16 is a processing unit configured to perform an overlap addition on the temporal waveform of the analysis frame and the temporal waveform obtained in the previous analysis frame. As an example, in a case where the temporal waveform of the analysis frame is output by the IFFT unit 15, the addition unit 16 adds the temporal waveform of the analysis frame and the temporal waveform of the immediately preceding analysis frame so as to overlap each other at a ratio corresponding to the overlap rate. A voice signal after noise suppression, which is obtained in this manner, may be output to an arbitrary output destination in accordance with the usage scene of the signal processing apparatus 10.

### Configuration of Noise Determination Unit 17

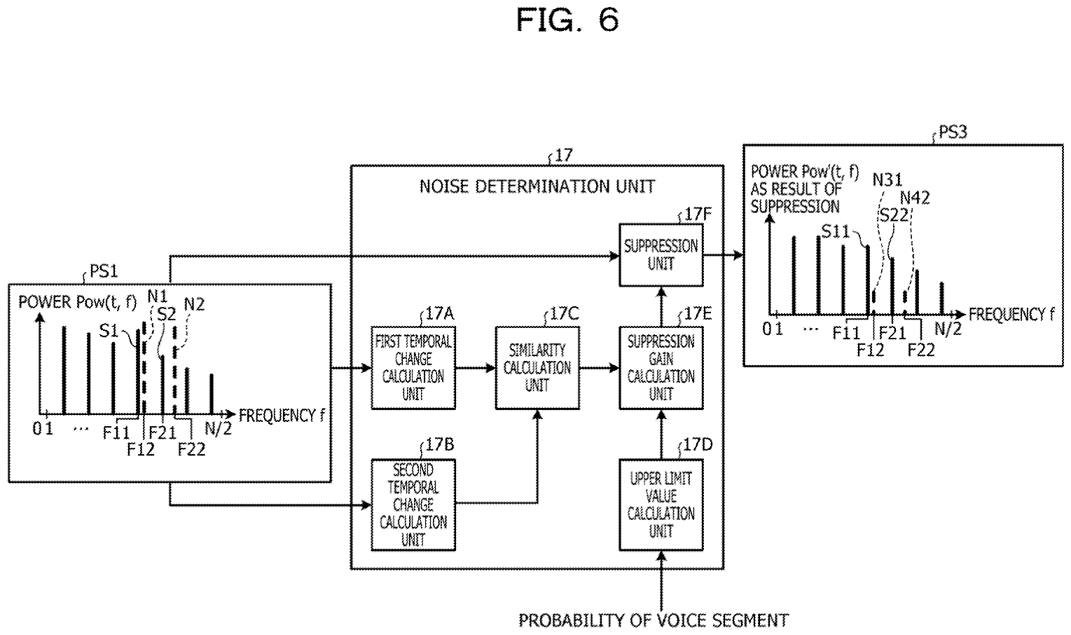

FIG. 6 is a block diagram illustrating an example of a functional configuration of the noise determination unit 17. FIG. 6 schematically illustrates blocks corresponding to the noise determination function described above. As illustrated in FIG. 6, the noise determination unit 17 includes a first temporal change calculation unit 17A, a second temporal change calculation unit 17B, a similarity calculation unit 17C, an upper limit value calculation unit 17D, a suppression gain calculation unit 17E, and a suppression unit 17F.

The first temporal change calculation unit 17A is a processing unit configured to calculate a temporal change in power in a low frequency band. The “low frequency band” referred to herein means a frequency band corresponding to a specific ratio, for example, ¼, from the lower side of a frequency range of the input signal. A DC component may be excluded from such a low frequency band.

As an example, the first temporal change calculation unit 17A calculates the power Pow_low(t) in the low frequency band, in accordance with the following expression (1). “t” in the following expression (1) indicates the number of the analysis frame. “f” in the following expression (1) indicates an index assigned to a frequency bin and is identified by a number from 0 to N-1, for example. “N” in the following expression (1) indicates the analysis frame length.

$$Pow\_ l o w ( t ) = {\sum }_{f = 1}^{N / B} Pow ( t , f ) \qquad Expression ( 1 )$$

for example, in the example of the above expression (1), the DC component corresponding to the index No. 0 of the frequency bin is removed by setting the index of the frequency bin for designating the lower limit value of f to No. 1. By setting No. N/8 to the index of the frequency bin for designating the upper limit value of f, the frequency band corresponding to ¼ of the frequency range may be designated to the upper limit of the low frequency band.

In the FFT, the temporal waveform of the analysis frame is transformed into a spectrum on the frequency axis, and a range from 0 Hz to a sampling frequency is discretized by the analysis frame length N (=512). From the viewpoint of the sampling theorem, since the frequency range of the temporal waveform is smaller than ½ of the sampling frequency, the total number of frequency bins included in the frequency range is N/2 when the DC component is also included. Therefore, in a case where ¼ of the frequency range is set as a low frequency band, the number of frequency bins included in the low frequency band is N/8 (=(N/2)/4). When the sampling frequency is set to 8 kHz and the analysis frame length is set to 512, the frequency resolution is approximately 15.6 Hz.

After the power Pow_low(t) in the low frequency band is calculated as described above, the first temporal change calculation unit 17A may calculate a temporal change R_Pow_low(t) of the power Pow_low(t) in the low frequency band in accordance with the following expression (2).

$$R \_ P o w \_low ( t ) = \frac{P o w \_low ( t )}{P o w \_low ( t - 1 )} \qquad Expression ( 2 )$$

The second temporal change calculation unit 17B is a processing unit configured to calculate a temporal change in power at each frequency. As an example, the second temporal change calculation unit 17B may calculate a temporal change R_Pow(t, f) of power Pow(t, f) at each frequency in accordance with the following expression (3).

$$R \_ P o w ( t , f ) = \frac{Pow ( t , f )}{Pow ( t - 1 , f )} \qquad Expression ( 3 )$$

The similarity calculation unit 17C is a processing unit configured to calculate a similarity between the temporal change in power in the low frequency band and the temporal change in power at each frequency. As an example, the similarity calculation unit 17C may calculate a similarity S(t, f) between the temporal change R_Pow_low(t) in power in the low frequency band and the temporal change R_Pow(t, f) in power at each frequency, in accordance with the following expression (4). As the value of the similarity S(t, f) approaches 1, it means that the temporal change in power in the low frequency band and the temporal change in power at each frequency are more similar to each other.

$$S ( t , f ) = \frac{R \_ P o w ( t , f )}{R \_ P o w \_low ( t )} \qquad Expression ( 4 )$$

The upper limit value calculation unit 17D is a processing unit configured to calculate the upper limit value of the suppression gain. As an example, the upper limit value calculation unit 17D calculates the upper limit value of the suppression gain based on the probability of the voice segment, for example, the likelihood. As an example of the probability of the voice segment, a ratio between power of the input signal in the current analysis frame and average power of a noise segment, which is calculated from the detection result of the voice segment by the voice segment detection unit 14, for example, a so-called SNR may be calculated in accordance with the following expression (5). For example, a larger value of the SNR means that the segment is more likely to be the voice segment. The denominator of the following equation (5) corresponding to “N” may correspond to average power (long-term average) of the stationary noise.

SNR=10 log₁₀(power of input signal/average power of noise segment) Expression (5)

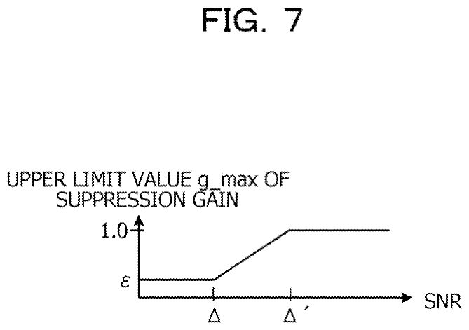

The upper limit value calculation unit 17D calculates the upper limit value g_max (≤1) of the suppression gain by using the above-described SNR. A look-up table, a function, and the like in which a correspondence relationship between the SNR and the upper limit value of the suppression gain is defined may be used to calculate such an upper limit value g_max of the suppression gain. FIG. 7 is a diagram illustrating an example of a relationship between the

SNR and the upper limit value of the suppression gain. A horizontal axis of a graph illustrated in FIG. 7 indicates an SNR, and a vertical axis of the graph indicates an upper limit value of the suppression gain. As illustrated in FIG. 7, in a look-up table, as the value of the SNR is higher, the higher upper limit value g_max of the suppression gain is defined. As an example, respectively regarding Δ, Δ′, and ε illustrated in FIG. 7, Δ=3.0 (dB), Δ′=6.0 (dB), and ε=0.25 are set.

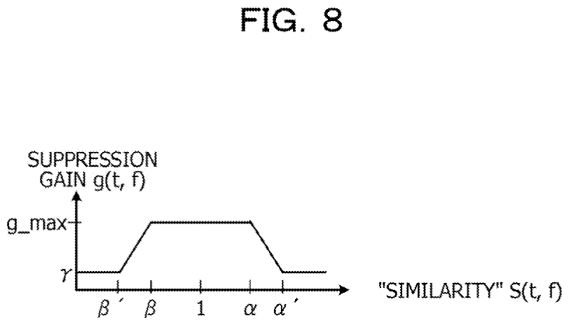

The suppression gain calculation unit 17E is a processing unit configured to calculate the suppression gain. As an example, the suppression gain calculation unit 17E calculates the suppression gain g(t, f) based on the upper limit value g_max of the suppression gain, which is calculated by the upper limit value calculation unit 17D, and the similarity S(t, f) calculated by the similarity calculation unit 17C. FIG. 8 is a diagram illustrating an example of a relationship between the suppression gain, the upper limit value of the suppression gain, and the similarity. As illustrated in FIG. 8, the suppression gain is calculated to decrease as the similarity is lower, for example, as the value of S(t, f) is farther from 1. As an example, respectively regarding α, α′, β, β′, and γ illustrated in FIG. 8, α=1.4, α′=2.0, β=0.7, β′=0.5, and γ=0.25 are set.

The suppression unit 17F is a processing unit configured to suppress the noise component of the power spectrum. As an example, the suppression unit 17F calculates a power spectrum Pow′(t, f) after the noise suppression, by multiplying the power spectrum Pow(t, f) at each frequency by the suppression gain g(t, f), as represented by the following expression (6).

Pow′(t,f)=g(t,f)Pow(t,f) Expression (6)

### Flow of Processing

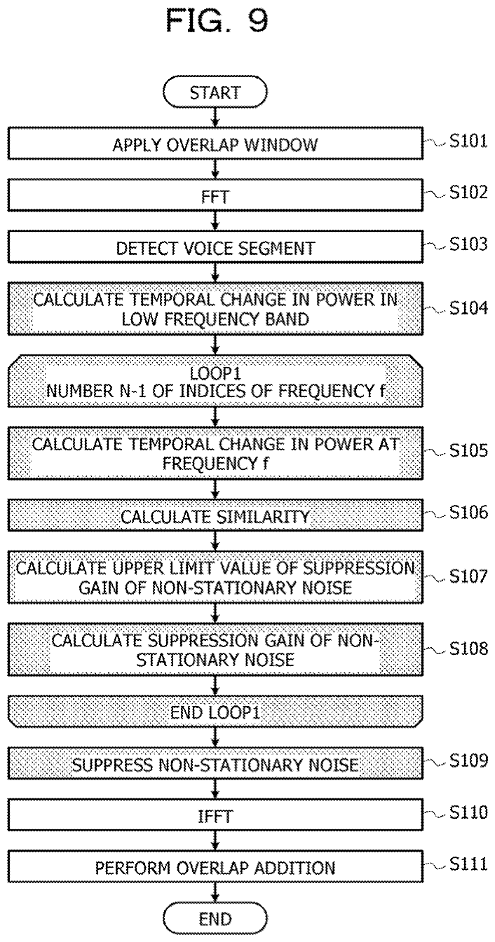

FIG. 9 is a flowchart illustrating a procedure of signal processing. As an example, the signal processing may be repeatedly performed at regular intervals until the input of the noise-mixed voice signal is ended. As illustrated in FIG. 9, the windowing unit 12 shifts the window function from an input signal of a noise-mixed voice signal, which is input by the input unit 11, by 50% of the analysis frame length, extracts the latest analysis frame, and applies the window function to the extracted analysis frame (step S101).

Then, the FFT unit 13 applies an FFT to the analysis frame to which the window function is applied in step S101 (step S102). The voice segment detection unit 14 detects a voice segment of the analysis frame obtained in step S101 (step S103).

Then, the first temporal change calculation unit 17A calculates a temporal change R_Pow_low(t) of power Pow_low(t) in a low frequency band from a power spectrum obtained by the FFT in step S102 (step S104).

Loop processing 1 of repeating the processes from the following step S105 to the following step S108 for the number of times corresponding to the number N-1 of frequency bins in the FFT performed in step S102 is started.

For example, the second temporal change calculation unit 17B calculates a temporal change R_Pow(t, f) in power Pow(t, f) in the frequency bin f during the loop processing, from the power spectrum obtained by the FFT in step S102 (step S105).

Then, the similarity calculation unit 17C calculates a similarity S(t, f) between the temporal change R_Pow_low(t) in power in the low frequency band, which is obtained in step S104, and the temporal change R_Pow(t, f) in power in the frequency bin f during the loop processing (step S106).

The upper limit value calculation unit 17D calculates an upper limit value g_max (≤1) of the suppression gain by using an SNR obtained from a detection result of the voice segment obtained in step S103 (step S107).

Then, the suppression gain calculation unit 17E calculates a suppression gain g(t, f) based on the upper limit value g_max of the suppression gain, which is calculated in step S107, and the similarity S(t, f) calculated in step S106 (step S108).

By repeating such loop processing 1, it is possible to obtain the suppression gain g(t, f) at each frequency from the first frequency bin to the N-th frequency bin. When the loop processing 1 is ended, the suppression unit 17F calculates a power spectrum Pow′(t, f) after the noise suppression, by multiplying the power spectrum Pow(t, f) at each frequency by the suppression gain g(t, f) (step S109).

Then, the IFFT unit 15 applies an IFFT to the phase spectrum output as a result of performing the FFT in step S102 and an amplitude spectrum obtained from the power spectrum Pow′(t, f) after the suppression, which is calculated in step 5109 (step 5110).

The addition unit 16 adds the first half 50% of a temporal waveform of the analysis frame obtained by the IFFT in step S110 and the second half 50% of the temporal waveform of the immediately preceding analysis frame so as to overlap each other (step S111), and then ends the processing.

In the flowchart illustrated in FIG. 9, an example in which the processes from the above-described step S105 to the above-described step S108 are executed as the loop processing is given, but the present disclosure is not limited to this example, and the processes may be executed in parallel.

### One Aspect of Effects

As described above, the noise determination unit 17 according to the present embodiment determines and suppresses, as non-stationary noise, a signal component of a frequency having a low similarity among similarities between a temporal change in power in a low frequency band and temporal changes in power at the respective frequencies, in a monaural signal.

FIG. 6 illustrates an example in which a power spectrum PS1 of a voice signal mixed with non-stationary noise that may not be completely suppressed by spectral subtraction suppression in the related art is input to the noise determination unit 17. Even when such a power spectrum PS1 is input, it is possible to realize suppression that targets a signal component of a frequency having a low similarity among similarities between the temporal change in power in the low frequency band and the temporal changes in power at the respective frequencies, for example, noise components N1 and N2. As a result, as represented by a power spectrum PS3 illustrated in FIG. 6, it is possible to suppress the power of residual noise components N31 and N42 corresponding to non-stationary noise, up to a level that does not exceed the threshold value for perception by the sense of hearing or a level at which the masking effect by the voice component is obtained.

Thus, with the noise determination unit 17 according to the present embodiment, it is possible to suppress non-stationary noise mixed in a voice signal.

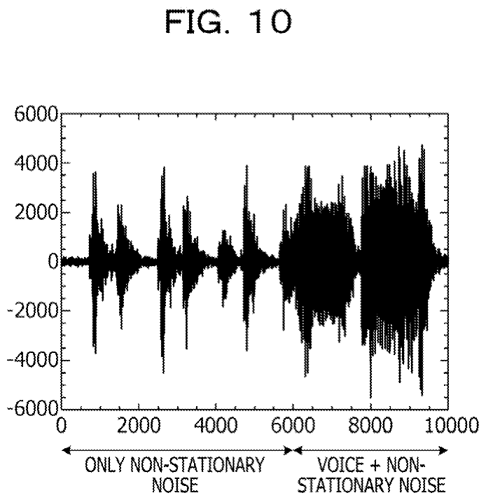

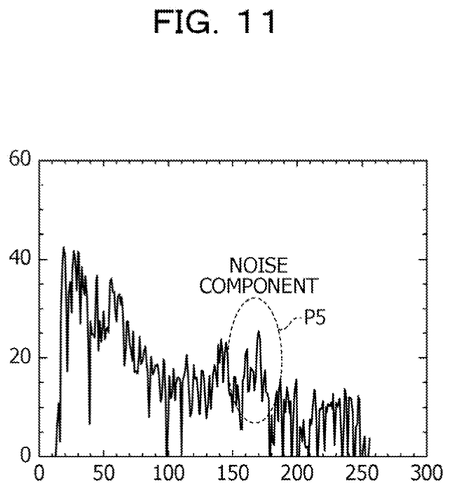

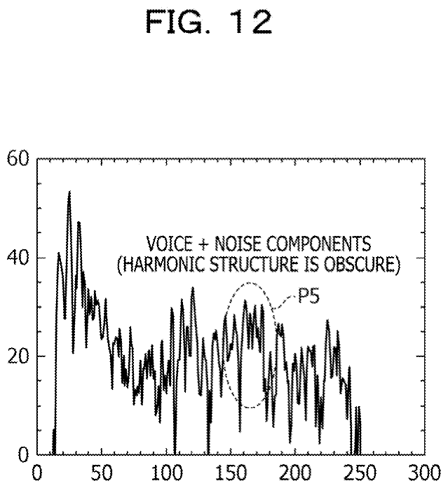

FIG. 10 is a diagram illustrating an example of the input signal of the noise-mixed voice. As illustrated in FIG. 10, the input signal includes a segment of a temporal waveform in which only non-stationary noise is included, and a segment of a temporal waveform in which a voice and non-stationary noise are present together. Among the sections, FIG. 11 illustrates a power spectrum of the former, and FIG. 12 illustrates a power spectrum of the latter. FIG. 11 is a diagram illustrating an example of a power spectrum of the non-stationary noise. FIG. 12 is a diagram illustrating an example of a power spectrum of the voice and the non-stationary noise. As illustrated in FIGS. 11 and 12, noise components in a band P5 included in the power spectrum of the non-stationary noise are superimposed on voice components in the band P5 of the power spectrum of the voice and the non-stationary noise, thereby obscuring the harmonic structure of the voice. Thus, it is difficult to perceive the voice.

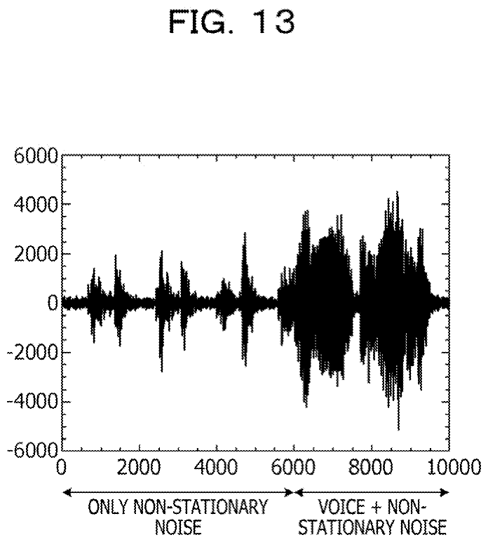

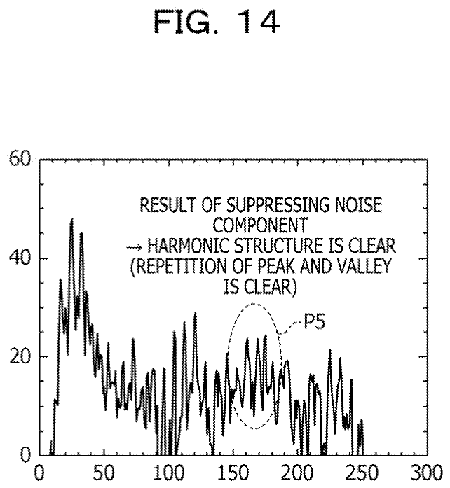

FIG. 13 is a diagram illustrating an example of a noise-mixed voice signal after suppression of the non-stationary noise. FIG. 14 is a diagram illustrating an example of a power spectrum after the suppression of the non-stationary noise. Comparing the voice signal after the suppression of the non-stationary noise, which is illustrated in FIG. 13, with the input signal of the noise-mixed voice illustrated in FIG. 10, it is apparent that it is possible to reduce a power level in the segment in which only the non-stationary noise is included, by applying the noise determination function according to the present embodiment to the noise illustrated in FIG. 11. Comparing the power spectrum after the suppression of the non-stationary noise, which is illustrated in FIG. 14, with the power spectrum illustrated in FIG. 12, it is apparent that the noise component in the band P5 is suppressed and the harmonic structure of the voice is clarified. Accordingly, with the noise determination function according to the present embodiment, it is possible to perceive the voice.

### Second Embodiment

While the embodiment relating to the apparatus of the disclosure has been described hitherto, the present disclosure may be carried out in various different forms other than the embodiment described above. Other embodiments of the present disclosure will be described below.

### Application Example

Although an example of performing control with changing the upper limit value of the suppression gain has been described in the first embodiment described above, the upper limit value of the suppression gain may not necessarily be controlled to be changed. In the present embodiment, an application example in which it is possible to fix the upper limit value of the suppression gain by switching noise suppression processing depending on whether an analysis frame is a voice segment or a non-voice segment will be described.

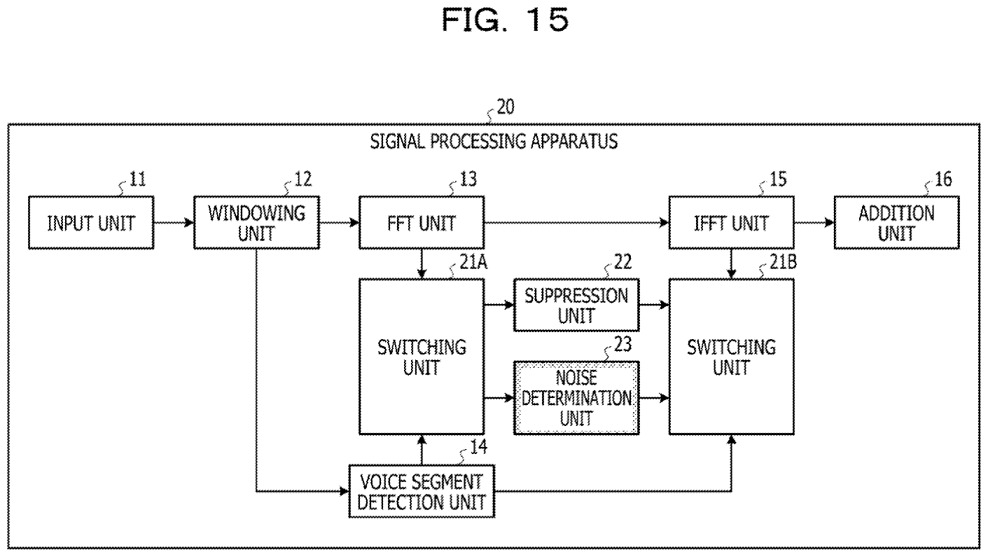

FIG. 15 is a block diagram illustrating an example of a functional configuration of a signal processing apparatus 20 according to the application example. Functional units in FIG. 15, that have substantially similar functions to the functional units illustrated in FIG. 1 are denoted by the same reference signs, and will not be described. As illustrated in FIG. 15, the signal processing apparatus 20 is different from the signal processing apparatus 10 illustrated in FIG. 1 in that the signal processing apparatus 20 further includes switching units 21A and 21B, a suppression unit 22, and a noise determination unit 23.

The switching unit 21A is a processing unit configured to switch whether the power spectrum obtained by the FFT are input to the suppression unit 22 or the noise determination unit 23. As one aspect, in a case where the analysis frame is a non-voice segment, the switching unit 21A inputs the power spectrum obtained by the FFT to the suppression unit 22. As another aspect, in a case where the analysis frame is a voice segment, the switching unit 21A inputs the power spectrum obtained by the FFT to the noise determination unit 23.

The switching unit 21B is a processing unit configured to input an output of either the suppression unit 22 or the noise determination unit 23 to the IFFT unit 15. As one aspect, in a case where the analysis frame is a non-voice segment, the switching unit 21B inputs the power spectrum suppressed by the suppression unit 22 to the IFFT unit 15. As another aspect, in a case where the analysis frame is a voice segment, the switching unit 21B inputs the power spectrum suppressed by the noise determination unit 23 to the IFFT unit 15.

The suppression unit 22 is a processing unit configured to suppress the power spectrum obtained by the FFT. As an example, the suppression unit 22 multiplies the power spectrum Pow(t, f) of each frequency, which is obtained by the FFT, by a uniform suppression gain, for example, 0.25.

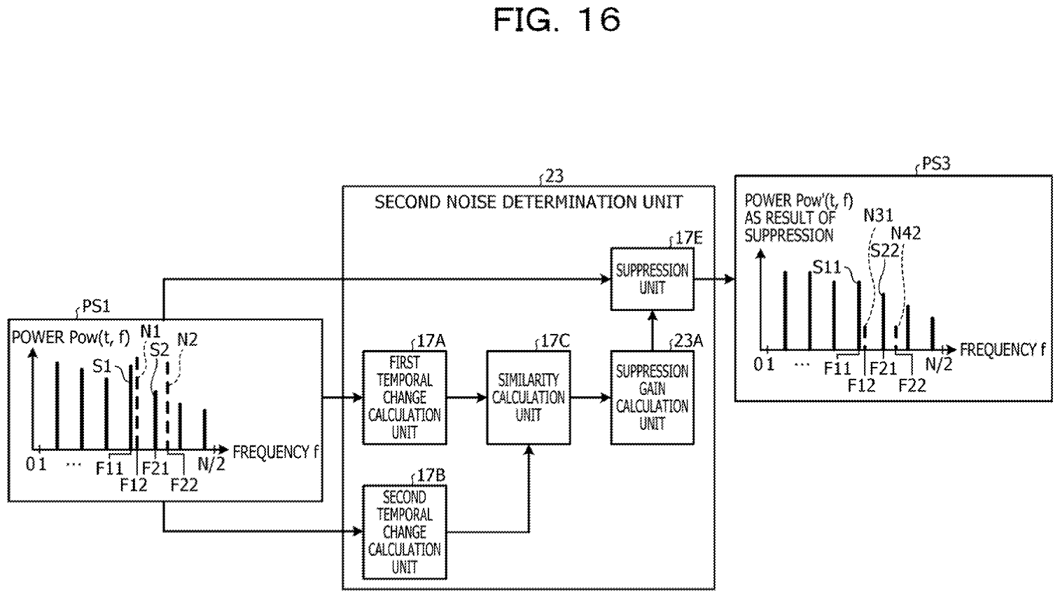

FIG. 16 is a block diagram illustrating an example of a functional configuration of the noise determination unit 23. Functional units in FIG. 16, that have substantially similar functions to the functional units illustrated in FIG. 6 are denoted by the same reference signs, and will not be described. As illustrated in FIG. 16, the noise determination unit 23 is different from the noise determination unit 17 illustrated in FIG. 1 in that the noise determination unit 23 includes a suppression gain calculation unit 23A having processing contents which are partially different from the processing contents of the suppression gain calculation unit 17E, and the noise determination unit 23 may not include the upper limit value calculation unit 17D.

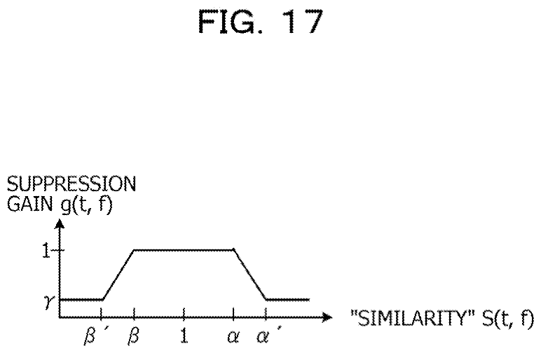

The suppression gain calculation unit 23A is different from the suppression gain calculation unit 17E in that the suppression gain g(t, f) is calculated based on the similarity S(t, f) calculated by the similarity calculation unit 17C with the upper limit value of the suppression gain set to a fixed value, for example, “1”. FIG. 17 is a diagram illustrating an example of a relationship between the suppression gain and the similarity. As illustrated in FIG. 17, the suppression gain is calculated to decrease as the similarity is lower, for example, as the value of S(t, f) is farther from 1. As an example, respectively regarding α, α′, β, β′, and γ illustrated in FIG. 8, α=1.4, α′=2.0, β=0.7, β′=0.5, and γ=0.25 are set.

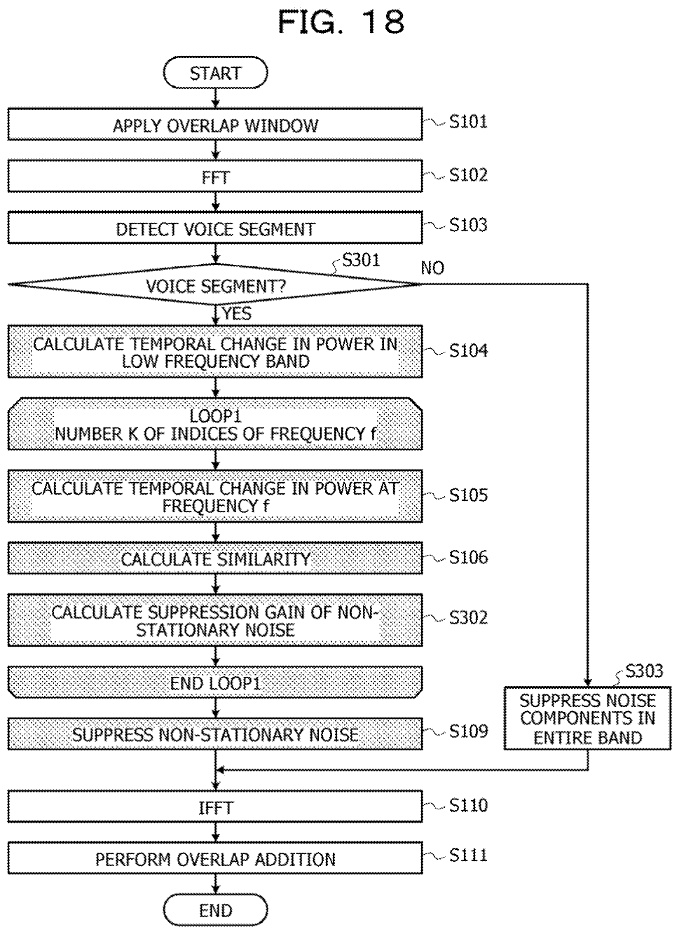

FIG. 18 is a flowchart illustrating a procedure of signal processing according to the application example. In FIG. 18, different step numbers are assigned to processes different from the processes in the flowchart illustrated in FIG. 9, while the same step numbers are assigned to the same processes as the processes in the flowchart illustrated in FIG. 9.

As illustrated in FIG. 18, the windowing unit 12 shifts the window function from an input signal of a noise-mixed voice signal, which is input by the input unit 11, by 50% of the analysis frame length, extracts the latest analysis frame, and applies the window function to the extracted analysis frame (step S101).

Then, the FFT unit 13 applies an FFT to the analysis frame to which the window function is applied in step S101 (step S102). The voice segment detection unit 14 detects a voice segment or a non-voice segment of the analysis frame obtained in step S101 (step S103).

At this time, in a case where the analysis frame is the voice segment (Yes in step S301), the first temporal change calculation unit 17A calculates the temporal change R_Pow_low(t) in power Pow_low(t) in the low frequency band from the power spectrum obtained by the FFT in step S102 (step S104).

Loop processing 1 of repeating the processes of step S105, step S106, and step S302 for the number of times corresponding to the number N-1 of frequency bins in the FFT performed in step S102 is started.

For example, the second temporal change calculation unit 17B calculates the temporal change R_Pow(t, f) in power Pow(t, f) in the frequency bin f during the loop processing, from the power spectrum obtained by the FFT in step S102 (step S105).

Then, the similarity calculation unit 17C calculates the similarity S(t, f) between the temporal change R_Pow_low(t) in power in the low frequency band, which is obtained in step S104, and the temporal change R_Pow(t, f) in power in the frequency bin f during the loop processing (step S106).

Then, the suppression gain calculation unit 23A calculates a suppression gain g(t, f) based on the fixed upper limit value, for example, “1” of the suppression gain and the similarity S(t, f) calculated in step S106 (step S302).

By repeating such loop processing 1, it is possible to obtain the suppression gain g(t, f) at each frequency from the first frequency bin to the N-th frequency bin. When the loop processing 1 is ended, the suppression unit 17F calculates a power spectrum Pow′(t, f) after the noise suppression, by multiplying the power spectrum Pow(t, f) at each frequency by the suppression gain g(t, f) (step S109).

On the other hand, in a case where the analysis frame is the non-voice segment (No in step S301), the suppression unit 22 performs the following processing. For example, the suppression unit 22 calculates the power spectrum Pow′(t, f) after the suppression, by multiplying the power spectrum Pow(t, f) at each frequency, which is obtained by the FFT, by a uniform suppression gain, for example, 0.25 (step S303).

Then, the IFFT unit 15 applies an IFFT to the phase spectrum output as a result of performing the FFT in step S102 and an amplitude spectrum obtained from the power spectrum Pow′(t, f) after the suppression, which is calculated in step S109 or S303 (step S110).

The addition unit 16 adds the first half 50% of a temporal waveform of the analysis frame obtained by the IFFT in step S110 and the second half 50% of the temporal waveform of the immediately preceding analysis frame so as to overlap each other (step S111), and then ends the processing.

In the flowchart illustrated in FIG. 18, an example in which the processes from step S105, step S106, and step S302 are executed as the loop processing is given, but the present disclosure is not limited to this example, and the processes may be executed in parallel.

As described above, also in the noise determination unit 23 according to the application example, similarly to the first embodiment described above, it is possible to suppress the non-stationary noise mixed in the voice signal and to fix the upper limit value of the suppression gain.

### Distribution and Integration

The individual components of each of the illustrated apparatuses do not necessarily have to be physically constructed as illustrated. For example, specific forms of the distribution and integration of the individual apparatuses are not limited to the illustrated forms, and all or part thereof may be configured in arbitrary units in a functionally or physically distributed or integrated manner depending on various loads, usage states, and the like. For example, some of the functional units included in the noise determination unit 17 or some of the functional units in the noise determination unit 23 may be coupled via a network, as an external device of the signal processing apparatus 10 or 20. Each of other devices may include some of the functional units included in the noise determination unit 17 or some of the functional units included in the noise determination unit 23, and may be coupled to each other via a network and cooperate with each other to implement the functions of the above-described signal processing apparatus 10 or 20.

Although the example in which the power spectrum is suppressed based on the similarity has been described in the first embodiment described above, it may be determined whether each frequency component is a voice or noise, based on the similarity. For example, it may be determined that, the possibility of noise is higher as the similarity is lower, and the possibility of a voice is higher as the similarity is higher. Although the example in which the temporal change in power in the low frequency band and the temporal change in power in each frequency bin are compared with each other has been described in the first embodiment described above, the power in the low frequency band and the power in each frequency bin may be compared with each other, and it may be determined whether each frequency component is a voice or noise, based on the similarity obtained by the comparison.

### Noise Determination Program

The various kinds of processing described in the embodiments described above may be implemented as a result of a computer such as a personal computer or a workstation executing a program prepared in advance.

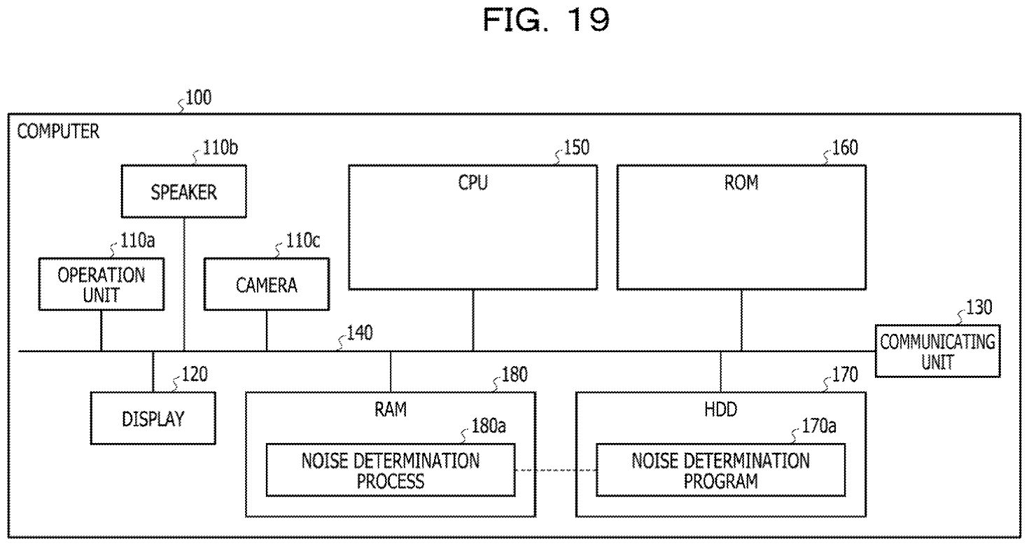

An example of a computer that executes a noise determination program having substantially the similar functions to those in the first and second embodiments will be described below with reference to FIG. 19.

FIG. 19 is a diagram illustrating an example of a hardware configuration. As illustrated in FIG. 19, a computer 100 includes an operation unit 110a, a speaker 110b, a camera 110c, a display 120, and a communication unit 130. The computer 100 also includes a central processing unit (CPU) 150, a read-only memory (ROM) 160, a hard disk drive (HDD) 170, and a random-access memory (RAM) 180. The operation unit 110a, the speaker 110b, the camera 110c, the display 120, the communication unit 130, the CPU 150, the ROM 160, the HDD 170, and the RAM 180 are coupled to each other via a bus 140.

As illustrated in FIG. 19, the HDD 170 stores a noise determination program 170a that exhibits the similar functions as those of the noise determination unit 17 described in the first embodiment described above or the noise determination unit 23 described in the second embodiment described above. The noise determination program 170a may be integrated or separated in the similar manner to each of the components of the noise determination unit 17 illustrated in FIG. 6 or the noise determination unit 23 illustrated in FIG. 16. For example, all the data described in the first embodiment above is not necessarily stored in the HDD 170, and data to be used for processing may be stored in the HDD 170.

Under such an environment, the CPU 150 reads out the noise determination program 170a from the HDD 170 to be loaded to the RAM 180. As a result, as illustrated in FIG. 19, the noise determination program 170a functions as a noise determination process 180a. The noise determination process 180a loads various types of data read from the HDD 170 in an area allocated to the noise determination process 180a in a storage area included in the RAM 180 and executes various types of processing using the various types of loaded data. For example, the processing performed by the noise determination process 180a includes the processing illustrated in FIG. 9 or 18, and the like. All the processing units described in the first embodiment above do not necessarily operate on the CPU 150, and processing units corresponding to the processing to be performed may be virtually implemented.

The above-described noise determination program 170a does not necessarily have to be initially stored in the HDD 170 or the ROM 160. For example, the noise determination program 170a is stored in “portable physical media” such as flexible disks called a flexible disk (FD), a compact disc (CD)-ROM, a Digital Versatile Disc (DVD), a magneto-optical disk, and an integrated circuit (IC) card, which will be inserted into the computer 100. The computer 100 may obtain the noise determination program 170a from these portable physical media and execute the program 170a. The noise determination program 170a is stored in another computer, a server device, or the like coupled to the computer 100 via a public line, the Internet, a local area network (LAN), a wide area network (WAN), or the like. The noise determination program 170a stored in this manner may be downloaded to the computer 100 and executed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a noise determination program for causing a computer to execute a process comprising:
comparing a sound pressure level for each frequency with a sound pressure level in a band having a frequency lower than a threshold value, in a spectrum of a voice signal; and
determining whether a component corresponding to each frequency is a voice or noise, based on a similarity between the sound pressure level for each frequency and the sound pressure level in the band.

2. The non-transitory computer-readable recording medium storing a noise determination program for causing a computer to execute a process according to claim 1, wherein
the comparing includes comparing a temporal change in the sound pressure level for each frequency with a temporal change in the sound pressure level in the band, and
the determining includes determining a frequency component having a low similarity between the temporal change in the sound pressure level for each frequency and the temporal change in the sound pressure level in the band, to be noise.

3. The non-transitory computer-readable recording medium storing a noise determination program for causing a computer to execute a process according to claim 2, further comprising:
calculating each of the temporal change in the sound pressure level for each frequency and the temporal change in the sound pressure level in the band, from a ratio of the sound pressure level between analysis frames for analyzing the spectrum.

4. The non-transitory computer-readable recording medium storing a noise determination program for causing a computer to execute a process according to claim 3, wherein
the calculating includes calculating, as the similarity, a ratio between the temporal change in the sound pressure level for each frequency and the temporal change in the sound pressure level in the band.

5. The non-transitory computer-readable recording medium storing a noise determination program for causing a computer to execute a process according to claim 1, further comprising:
suppressing a frequency component determined to be noise in the determining.

6. The non-transitory computer-readable recording medium storing a noise determination program for causing a computer to execute a process according to claim 5, wherein
the suppressing includes performing switching between suppression of the frequency component determined to be noise in the determining and suppression of all frequency components, in accordance with a detection result of a voice segment for the voice signal.

7. A noise determination method comprising:
comparing, by a computer, a sound pressure level for each frequency with a sound pressure level in a band having a frequency lower than a threshold value, in a spectrum of a voice signal; and
determining whether a component corresponding to each frequency is a voice or noise, based on a similarity between the sound pressure level for each frequency and the sound pressure level in the band.

8. The noise determination method according to claim 7, wherein
the comparing includes comparing a temporal change in the sound pressure level for each frequency with a temporal change in the sound pressure level in the band, and
the determining includes determining a frequency component having a low similarity between the temporal change in the sound pressure level for each frequency and the temporal change in the sound pressure level in the band, to be noise.

9. The noise determination method according to claim 8, further comprising:
calculating each of the temporal change in the sound pressure level for each frequency and the temporal change in the sound pressure level in the band, from a ratio of the sound pressure level between analysis frames for analyzing the spectrum.

10. The noise determination method according to claim 9, wherein
the calculating includes calculating, as the similarity, a ratio between the temporal change in the sound pressure level for each frequency and the temporal change in the sound pressure level in the band.

11. The noise determination method according to claim 7, further comprising:
suppressing a frequency component determined to be noise in the determining.

12. The noise determination method according to claim 11, wherein
the suppressing includes performing switching between suppression of the frequency component determined to be noise in the determining and suppression of all frequency components, in accordance with a detection result of a voice segment for the voice signal.

13. An information processing apparatus comprising:
a memory; and
a processor coupled to the memory and configured to:
compare a sound pressure level for each frequency with a sound pressure level in a band having a frequency lower than a threshold value, in a spectrum of a voice signal; and
determine whether a component corresponding to each frequency is a voice or noise, based on a similarity between the sound pressure level for each frequency and the sound pressure level in the band.

14. The information processing apparatus according to claim 13, wherein
the processor compares a temporal change in the sound pressure level for each frequency with a temporal change in the sound pressure level in the band, and determines a frequency component having a low similarity between the temporal change in the sound pressure level for each frequency and the temporal change in the sound pressure level in the band, to be noise.

15. The information processing apparatus according to claim 14, wherein the processor calculates each of the temporal change in the sound pressure level for each frequency and the temporal change in the sound pressure level in the band, from a ratio of the sound pressure level between analysis frames for analyzing the spectrum.

16. The information processing apparatus according to claim 15, wherein
the processor calculates, as the similarity, a ratio between the temporal change in the sound pressure level for each frequency and the temporal change in the sound pressure level in the band.

17. The information processing apparatus according to claim 13, wherein
the processor suppresses a frequency component determined to be noise in the determining.

18. The information processing apparatus according to claim 17, wherein
the processor performs switching between suppression of the frequency component determined to be noise in the determining and suppression of all frequency components, in accordance with a detection result of a voice segment for the voice signal.
